(19) United States
(12) Patent Application Publication
(10) Pub. No.: US 2007/0217348 A1
(43) Pub. Date: Sep. 20, 2007

(54) Method, Device and System With Signal Quality Target for Radio Frequency Power Control in Cellular Systems

(76) Inventors: Pablo Tapia Moreno, Malaga (ES); Wei Chao, Beijing (CN)

Correspondence Address: Hollingsworth & Funk, 8009 34th Avenue South, Suite 125, Minneapolis, MN, 55425, US

(21) Appl. No.: 10/583,788

(22) PCT Filed: Dec. 22, 2003
(86) PCT No.: PCT/IB03/06107

§ 371 Date: Apr. 2, 2007

(51) Int. Cl. H04B 7/005

(52) U.S. Cl. 370/278

(57) ABSTRACT

Improved power control mechanism for cellular time division duplex systems supporting multislot services. The improved power control mechanism allows for individual adaptation transmission power control (TPC) commands to time slot specific interference conditions in case several time slots are assigned to one composite transmission channel (CTrCH).

The present invention relates to a method for operating radio frequency power control and devices and system allowing for performing said method. In particular, the radio frequency power control relates to a fast power control for radio frequency transmission systems being based on time division duplex (TDD).

The evolution of analog cellular phone systems referred to as first generation systems to digital systems currently in use referred to as second generation systems represents one major step in technology to the information society. The economical success of the second generation systems is reflected by the wide spread of cellular terminals, which exceeds significantly the number of wired phone terminals in several industrial states, expressing the need of modern society for permanent attainability and instantaneous information exchange. Second generation systems such as GSM (global system for mobile communications), PDC (personal digital cellular), cdmaOne (IS-95) and US-TDMA (IS-136) have been developed primarily for enabling wireless voice communications. During operation of those systems customers have increasingly found advantages in the use of other wireless services such as messaging services (e.g. short message service) and data access services (e.g. i mode); but the second generation systems lack significantly in requirements and perquisites, which are essential for enhanced messaging and data access services.

Third generation systems, which introduction now is imminent although the introduction thereof was scheduled years before, are developed with design prerequisites addressing enhanced communications which require for instance high data transmission bandwidth, quality of service to enable for instance high quality image and video communications and fast data access services on private and public packet-switched networks, respectively. Although the third generation systems are introduced now detail developments and improvements are still under work, which reflects the complexity of the third generation systems caused by the challenging design prerequisites. Although the development of the third generation systems has been brought together in an umbrella organization, the third generation partnership project (3GPP), the original target of the third generation process was a single common global air interface. This goal was not achieved. Whereas Europe and Asia including Japan and Korea have decided to adopt WCDMA (wideband code division multiple access) air interface, North America embeds third generation services into the existing second generation systems by adopting EDGE (enhanced data rates for GSM evolution) and multicarrier CDMA (cdma2000). The WCDMA standard covers UTRAN-FDD (UMTS terrestrial radio access network—frequency division duplex) systems and UTRAN-TDD (UMTS terrestrial radio access network—time division duplex) systems, the applicability of which primarily depends on the availability of corresponding frequency bands therefor. The China Telecommunication Standard group (CWTS) has pushed ahead its own third generation system referred to as TD-SCDMA (time division synchronous code division multiple access) by migrating the current GSM standard to a time division duplex system allowing symmetric and asymmetric downlink data communications with an adaptive CDMA component. The TD-SCDMA is approved by the International Telecommunications Union (ITU) and included in the WCDMA-UTRAN-TDD standard.

The radio resource efficiency is a main issue of third generation systems and particularly of WCDMA systems. The efficient use of radio resources relates different fields comprising especially individual data rates of mobile terminals subscribed within a cell of such a WCDMA system, total number of mobile terminals subscribed within the cell and total data rate within available within cell; only to enumerate a selection of related fields. For radio resource efficiency CDMA systems and correspondingly WCDMA systems implement power control mechanisms. The power control mechanisms are implemented to guarantee that a radio frequency signal emitted by a cellular transceiver of either a cellular terminal (UE) or a base station (BS) will be received with a suitable radio frequency power level determined as far as possible. The suitable radio frequency power level is among others determined by required data rates and data reliability in conjunction with environmental effects such as near-far problematic, path loss, fast Rayleigh fading etc.

In order to accomplish power control WCDMA standard purposes the implementation of outer loop and inner loop power control applicable for radio frequency signal power control of physical channels for both data transmission directions, i.e. downlink (from base station to cellular terminal) and uplink (from cellular terminal to base station) direction is envisaged.

The object of the present invention is to provide an improved power control mechanism applicable with power control of the WCDMA standard. More particularly, the object of the present invention is to provide an enhanced inner loop power control mechanism particularly applicable with time division duplex systems supporting multislot services.

The object of the present invention is attained by a mechanism, an apparatus and a system for adjusting radio frequency transmission power selectively for each time slot.

The advantage of the present invention is to achieve principally lower transmission powers for the data transmission, which means that the transmission powers are optimal and less interference in the radio network occurs which results in an increase of the overall network quality and capacity with economic radio resource management. The present invention is advantageously implementable with any UTRAN TDD (UMTS terrestrial radio access network—time division duplex) system and especially applicable with TD-SCDMA (time division synchronous code division duplex multiple access) systems.

According to a first aspect of the invention, a method for improved transmission power controlling in time division duplex cellular systems supporting multislot services for data communications is provided. A common target signal quality level and individual service quality levels relating to separate individual time slots are obtained, wherein the individual time slots are assigned to one composite transport channel for transmission of a data stream which results for a combination of one or more separate transport channels. Individual target signal quality offset levels relating to the respective time slots are determined in accordance with the individual service quality levels. Then individual target signal quality levels relating to the respective time slots are determined on the basis of the common target signal quality level and individual target signal quality offset levels. Finally, transmission power controlling relating to the respective time slots is obtainable in accordance with the determined individual target signal quality levels such that transmission power control is adapted to specific interference conditions of each time slot.

According to an embodiment of the invention, the individual target signal quality offset levels are determined by mapping the individual service quality levels from a service quantity scale to a signal quantity scale. The mapping may be defined as a relationship associating service quality level values and signal quality level values.

According to another embodiment of the invention, the individual target signal quality offset levels are determined by mapping a difference between the individual service quality levels and a combined individual service quality level.

According to yet another embodiment of the invention, the combined individual service quality level is defined as a function of the individual service quality levels. The functional relationship between individual service quality levels and combined individual service quality level is not limited to any specific function, but the functional relationship may preferably be an averaging functional relationship such as arithmetic averaging, geometric averaging, weighted averaging, quadratic averaging, harmonic averaging and the like.

According to a further embodiment of the invention, the individual service quality levels are bit error ratios (BER).

According to yet a further embodiment of the invention, the common target signal quality level is adjusted in accordance with a common target service quality level and a common measured service quality level being determined from the data transmitted on the composite transport channel. Particularly, the service quality levels are data reliably quantities such as a block error ratio (BLER) or other soft data reliably information.

According to an additional embodiment of the invention, the common target signal quality level is obtainable from an outer loop power control mechanism.

According to an embodiment of the invention, the common target signal quality level is a common target signal to interference ratio (SIR).

According to another embodiment of the invention, the transmission power controlling is capable for issuing transmission power control commands for each time slot. The transmission power controlling is applicable for data communications in uplink and/or downlink direction.

According to yet another embodiment of the invention, the composite transport channel is a coded composite transport channel.

According to a further embodiment of the invention, the time division duplex cellular system is a wideband code division multiple access—time division duplex (WCDMA-TDD) system and particularly a time division synchronous code division multiple access (TD-SCDMA) system.

According to a second aspect of the invention, computer program product for executing the method for improved transmission power controlling in time division duplex cellular systems supporting multislot services is provided. The computer program product comprises program code sections for carrying out the steps of the method according to an aforementioned embodiment of the invention, when the program is run on a computer, a terminal, a network device, a mobile terminal, a mobile communication enabled terminal or an application specific integrated circuit. Alternatively, an application specific integrated circuit (ASIC) may implement one or more instructions that are adapted to realize the aforementioned steps of the method of an aforementioned embodiment of the invention, i.e. equivalent with the aforementioned computer program product.

According to a third aspect of the invention, a computer program product is provided, which comprises program code sections stored on a machine-readable medium for carrying out the steps of the method according to an aforementioned embodiment of the invention, when the computer program product is run on a computer, a terminal, a network device, a mobile terminal, or a mobile communication enabled terminal.

According to a fourth aspect of the invention, a computer data signal embodied in a carrier wave and representing instructions is provided which when executed by a processor cause the steps of the method according to an aforementioned embodiment of the invention to be carried out.

According to a fifth aspect of the invention, a transmission power controller for time division duplex cellular systems supporting multislot services is provided. The transmission power controller comprises at least means for obtaining a common target signal quality level; and means for obtaining individual service quality levels. Each of the individual service quality levels relates to one of several individual time slots. The individual time slots are assigned to one composite transport channel for a data stream. The composite transport channel, which results from a combination of one or several transport channels.

The transmission power controller comprises further means for determining individual target signal quality offset levels on the basis of the individual service quality levels. Each of the individual target signal quality offset levels relates to one of the individual time slots. The transmission power controller comprises additionally means for determining individual target signal quality levels on the basis of the common target signal quality level and the individual target signal quality offset levels. Each of the individual target signal quality levels relates to one of the individual time slots. The transmission power controller is able to specifically adapt transmission power to individual interference conditions of each individual time slot.

According to an embodiment of the invention, the means for determining individual target signal quality offset levels comprises means for mapping the individual service quality levels from a service quantity scale to a signal quantity scale.

According to another embodiment of the invention, the transmission power controller comprises means for mapping a difference between the individual service quality levels and a combined individual service quality level in order to determine the individual target signal quality offset levels.

According to another embodiment of the invention, the transmission power controller comprises means for adjusting the common target signal quality level in accordance with a common target service quality level and a common measured service quality level being determined from the data transmitted on the composite transport channel.

According to yet another embodiment of the invention, the individual service quality levels are bit error ratios.

According to a further embodiment of the invention, the common target signal quality level is a common target signal to interference ratio

According to yet a further embodiment of the invention, the transmission power controller comprises an outer loop power control mechanism, from which the common target signal quality level is obtainable.

According to an additional embodiment of the invention, the transmission power controller is provided for wideband code division multiple access—time division duplex (WCDMA-TDD) systems and particularly for time division synchronous code division multiple access (TD-SCDMA) systems.

According to a sixth aspect of the invention, a cellular terminal is provided, which is capable to operate in time division duplex cellular systems supporting multislot services. The cellular terminal comprises at least a transmission power controller for adjusting transmission power control of downlink data transmissions. The transmission power controller corresponds to one of the embodiments of the transmission power controller described above.

According to a seventh aspect of the invention, a base station is provided, which is provided for time division duplex cellular systems supporting multislot services. The base station comprises at least a transmission power controller for adjusting transmission power control of uplink data transmissions. The transmission power controller corresponds to one of the embodiments of the transmission power controller described above.

According to an eighth aspect of the invention, a radio access network (RAN) system is provided, which is provided for operating cellular time division duplex systems supporting multislot services. The radio access network system comprises at least one base station and at least on radio network controller. The radio access network( system comprises additionally a transmission power controller for adjusting transmission power control of uplink data transmissions. The transmission power controller corresponds to one of the embodiments of the transmission power controller described above. The transmission power controller may be implemented as a distributed transmission power controller partly integrated in the radio network controller and partly integrated in the base station.

The accompanying drawings are included to provide a further understanding of the invention, and are incorporated in and constitute a part of this specification. The drawings illustrate embodiments of the invention, and together with the description, serve to explain the principles of the invention. In the drawings,

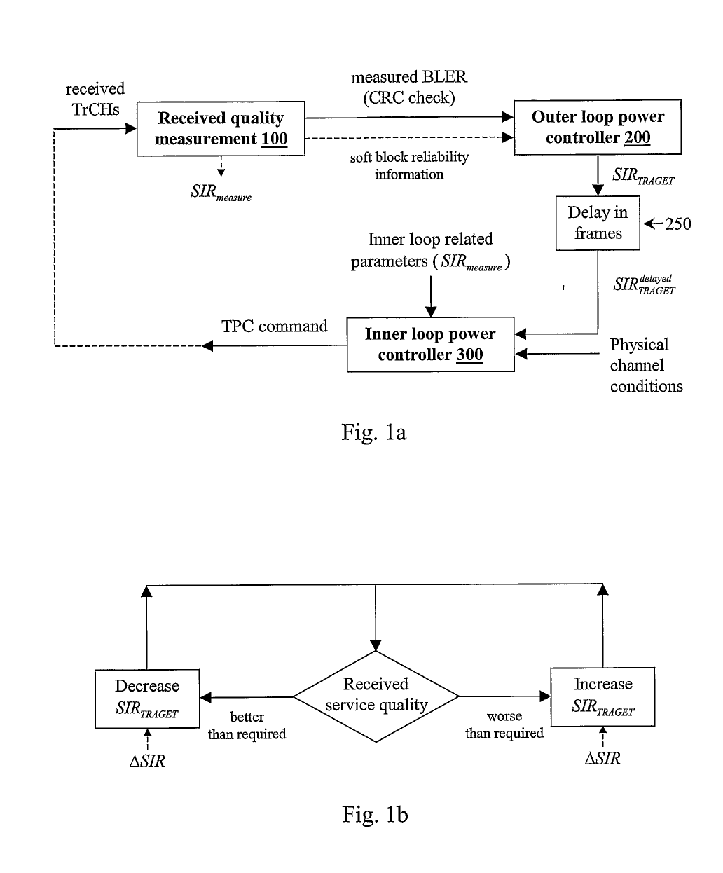

FIG. 1a schematically illustrates a block diagram of a power control mechanism including outer loop power control and inner loop power control according to an embodiment of the present invention;

FIG. 1b schematically illustrates a block diagram of an outer loop power control mechanism according to an embodiment of the present invention;

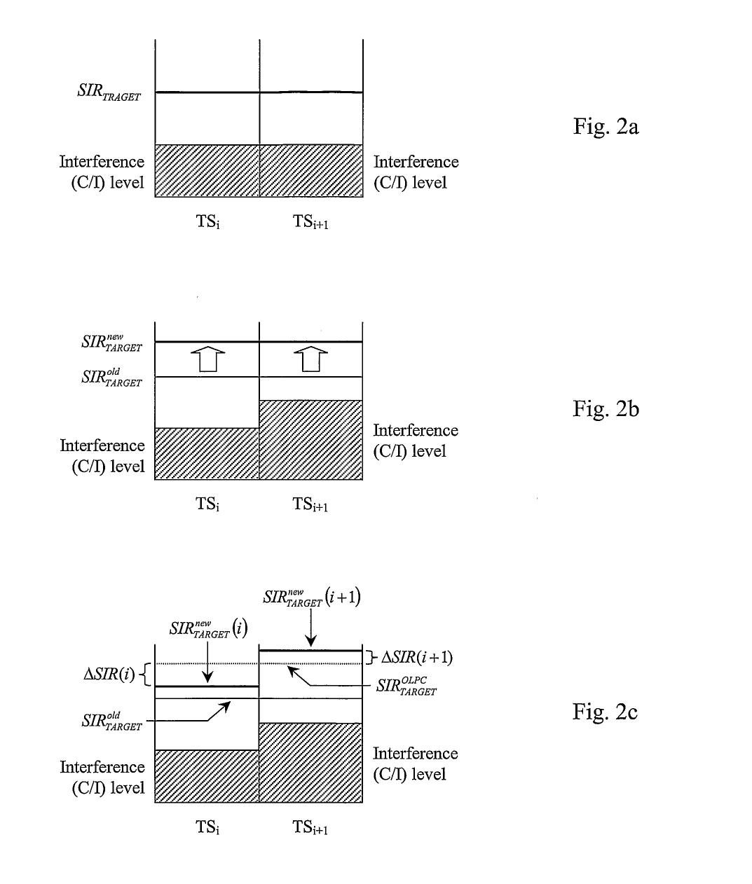

FIG. 2a schematically illustrates a first power control level diagram;

FIG. 2b schematically illustrates a second power control level diagram when performing the state of the art inner loop power adaptation mechanism;

FIG. 2c schematically illustrates a third power control level diagram when performing an inner loop power adaptation mechanism according to the invention; and

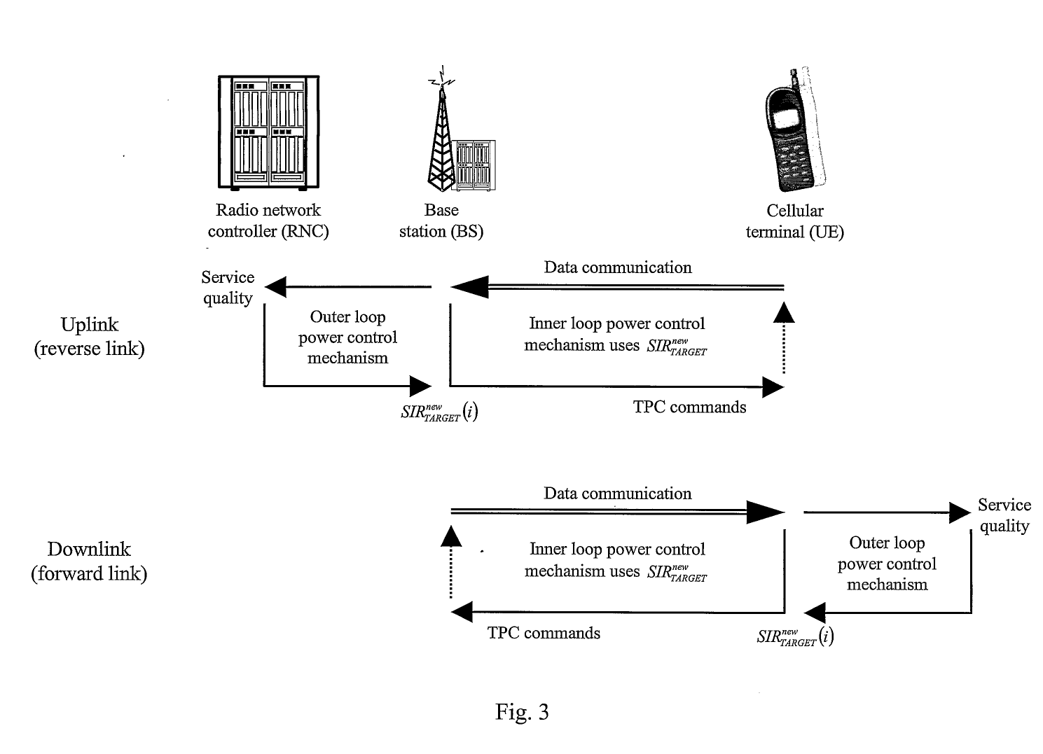

FIG. 3 schematically illustrates a sequence diagram comprising network entities of a radio access network and a cellular terminal to illustrate power control mechanism operation according to an embodiment of the invention.

The description will particularly refer to the TD-SCDMA (time division synchronous code division multiple access) standard as a reference system supporting multislot services for data transmission in uplink and/or downlink directions. The TD-SCDMA standard is distinguished by an access scheme being direct-sequence code division multiple access (DS-CDMA) with information spread over approximately 1.6 MHz bandwidth in TDD (time division duplex) for operating with unpaired bands respectively. TDD mode is defined as a duplex method whereby forward link (downlink) and reverse link (uplink) transmissions are carried over same radio frequency by using synchronized time intervals. In the TDD, time slots in a physical channel are divided into transmission and reception part. Information on forward link and reverse link are transmitted reciprocally. In TD-SCDMA, there is TDMA component in the multiple access in addition to DS-CDMA. Thus, the multiple access is also often denoted as TDMA/CDMA due to added TDMA nature. The carrier separation is 1.6 MHz depending on the deployment scenario with 200 Hz carrier raster. A 10 ms radio frame is divided into two 5 ms sub-frames. In each sub-frame, there are 7 main time slots and 3 special time slots. A basic physical channel is therefore distinguished by the frequency, code and time slot. TD-SCDMA uses the same 72-frame superframe structure as suggested by UTRAN (UMTS terrestrial radio access network).

The time division multiple access (TDMA) in combination with time division duplex (TDD) allows to process network traffic in both directions, per uplink and downlink. Specifically, TDMA uses the 5 ms sub-frame for repetitive transmissions, which sub-frame is subdivided into 7 time slots, which can be flexibly assigned to either several users or to a single user requiring multiple time slots. TDD principles permit network traffic to be uplinked and downlinked using the same frame and different time slots. For asymmetric services, where for instance large amount of data is transmitted from the base station to the cellular terminal, more time slots are used for the downlink than the uplink.

As introduced above power control mechanisms are essential for efficient operation of cellular terminals within a cell providing shared radio resources. The power control mechanisms take the requirement into account to adjust, correct and manage the transmission power of radio frequency signals from the base station and the cellular terminal in both directions (i.e. uplink and downlink) in an efficient manner. Generally, the purpose of power control is to minimize interference within the system, to alleviate co-channel and cross-channel interference to enhance resource sharing. Dominant factors to be taken into consideration may be caused by several different effects such as Doppler shift, imperfect orthogonality, imperfect synchronization, multipath situations, incorrect time slots, near-far problematic, cell topology and hierarchy, environmental morphology and topology, terminal velocity, uplink-downlink differences and several further effect.

Beneath interference prevention techniques such as sectorization, voice activity monitoring, beam forming techniques, diversity techniques, power control technique is employed in cellular systems. Power control technique primarily addresses the near-far problematic, distance losses, shadowing and multipath and Rayleigh fading and is especially effective in view of co-channel interference. Typically, WCDMA systems but also other cellular systems implement different power control mechanisms adapted to specific operations comprising in principle two mechanisms designated as open loop power control and closed loop power control. The closed loop power control in turn can be partitioned into outer loop power control and inner loop power control.

Open loop power control is typically used for initial setting uplink and downlink transmission power and particular for initial setting a coarse initial uplink transmission power at the beginning of the transmission. The transmitting entity (i.e. a cellular terminal or a base station) estimates the channel quality on a reverse link for determining a suitable transmission power of the forward link on the basis of the determined channel quality and vice versa, respectively. The open loop power control lacks in several deficiencies, one of which relates to the incapability for tracking fast fading.

The (fast) closed loop power control represents a more complex solution being based on a feedback control loop. The closed loop power control in its simplest embodiment is represented by the inner loop power control for controlling transmission power in both uplink and downlink directions. The receiving entity (i.e. a base station or a cellular terminal) measures the signal quality of radio frequency transmission signals transmitted by the transmitting entity (i.e. the cellular terminal and the base station, respectively). The measured signal quality is compared with a target signal quality and the receiving entity instructs the transmitting entity to adjust the transmission power for radio frequency transmission signals. That means the transmission power may be maintained, in case the measured signal quality corresponds substantially to the target signal quality, the transmission power may be increased in case the measured signal quality is too low in comparison with the target signal quality or the transmission power may be decreased in case the measured signal quality is too high in comparison with the target signal quality. Accordingly, a measure-command-reaction system representing the feedback system for transmission power control is established. The designation fast closed loop power control results from the fact that the adjustments of the transmission power happen at a high rate, i.e. for instance sufficient fast to overcome path loss changes and Rayleigh fading effects.

The above described inner loop power control can be improved by combining with outer loop power control. The outer loop power control is also applicable for controlling transmission power in both uplink and downlink directions. FIG. 1a schematically illustrates a block diagram of such a power control mechanism including outer loop power control and inner loop power control according to an embodiment of the present invention. The user-perceived service quality is not inevitably identical with the measured signal quality, which is conventionally defined on the basis of physical values obtained from the radio frequency signals received. The user-perceived service quality is more reliably describable with measure quantities relating to error ratio values obtained from the data coded by received radio frequency transmission signals. A suitable service quality may be obtained from the error detection for instance on the basis of cyclic redundancy check (CRC) or can be estimated on soft reliability information comprising block error ratio (BLER), frame error ratio (FER), bit error ratio (BER), raw or physical bit error ration (BER_{RAW}), received E_{b}/E₀ (signal quality per bit divided by noise spectral density), soft information from Viterbi decoder with convolutional codes, soft information from turbo encoder and the like.

The outer loop power control corresponds to a supplementary iteration within the inner loop power control. The outer loop power control serves to adapt flexibly the target signal quality on the basis of the measured service quality. FIG. 1b schematically illustrates a block diagram of an outer loop power control mechanism according to an embodiment of the present invention. The received service quality is measured by the receiving entity. In case the received service quality is better than required, the signal quality is decreased and, in case the received service quality is worse than required, the signal quality is increased. The required service quality is in turn defined on the basis of a target service quality.

The outer loop power control mechanism allows transferring the feedback control mechanism from physical signal integrity quality measures to data reliability quality measures, which are comparable with service requirements. For instance, speech services can support soft error ratios at several percent without noticeable degradation and non-real time data services can support much higher soft error ratios since retransmission is applicable without significant degradation of the non-real time service quality, where the degradation may result in a reduction of an overall data throughput or a delay in operation. Real time data services can significantly degrade in quality, which often is reflected by stringent service demands relating to data reliability. Such stringent service demands can be fulfilled by defining a suitable target service quality for the outer loop power control mechanism described above.

With back reference to FIG. 1a, the power control mechanism in question including inner loop power control and outer loop power control is schematically illustrated. A receiving entity, i.e. either a base station or a cellular terminal, receives radio frequency signals being associated with one or more transport channels (TrCHs) originating from the corresponding far end transmitting entity, i.e. a cellular terminal and a base station, respectively. The service quality of the data transmitted on the one or more transport channels (TrCHs) is measured by a received quality measurement 100 resulting for instance in a measured block error ratio (BLER) obtained by cyclic redundancy check (CRC) or adequate soft block reliability information. This service quality is supplied to the outer loop power controller 200, which adjusts the target signal quality, herein the target signal to interference ratio (SIR_{TARGET}). That means that a new target signal to interference ratio (SIR_{TARGET}) is estimated which is assumed to be more suitable for receiving data on the transmission channels (TrCHs) of a desired service quality determined by a target service quality. The target service quality such as the target block error ration (BLER_{TARGET}) is a function of the service being operated over the transmission channels (TrCHs). The estimation of the new target signal to interference ratio (SIR_{TARGET}) is conventionally based on the actual target signal to interference ratio increased and decreased by a predefined signal to interference ratio update step (ΔSIR).

The adjusted new target signal to interference ratio (SIR_{TARGET}) can now be supplied to the inner loop power control. However, an improved outer loop power control mechanism may take time delay compensation into consideration, which allows to adapt the adjustment of the target signal quality on the basis of the outer loop power control mechanism to also reflect issued transmission power control (TPC) commands that not yet have taken effect. Processing and signaling is time consuming, which causes time delays in the overall control feedback loop. The time consumption is conventionally described in term of sampling intervals or power update intervals, herein described in time delay frames. The time delay compensation 250 supplied with the target signal to interference ratio (SIR_{TARGET}) provides a time delay compensated target signal to interference ratio (SIR_{TARGET}^{delayed}), which is accordingly adapted.

The time delay compensated target signal to interference ratio (SIR_{TARGET}^{delayed}) is afterwards supplied to the inner loop power controller 300, which finally generates and issues transmission power (TPC) commands. The inner loop power control mechanism is conveniently supplied with further inner loop related parameters, which comprise at least a measured signal quality (SIRₘₑₐₛᵤᵣₑ), to allow the generation of the transmission power (TPC) commands. Preferably, the signal quality (SIRₘₑₐₛᵤᵣₑ) is additionally obtained from the received quality measurement 100.

Nevertheless, the outer loop power control mechanism as outlined above can result in waste of radio resources, especially in WCDMA TDD systems and more especially in TD-SCDMA systems. As explained above in detail, TD-SCDMA systems support multislot services; i.e. several time slots are permitted to be grouped and to be associated with one transport channel for data transmission.

For instance it shall be assumed that there exist multiple time slots assigned to one transport channel (TrCH) such as a code composite transport channel (CCTrCH/CCTCH). The quality quantity used for inner loop power control shall be the signal to interference ratio, which is estimated in each slot in form of an estimated signal to interference ratio (SIRₘₑₐₛᵤᵣₑ) and compared with the target signal to interference ratio (SIR_{TARGET}) provided by outer loop power control. Correspondingly, a transmission power control (TPC) command is generated for each time slot individually to adjust the transmission power in accordance with the comparison of the estimated signal to interference ratio (SIRₘₑₐₛᵤᵣₑ) and the target signal to interference ratio (SIR_{TARGET}). It can be seen that one common target signal to interference ratio (SIR_{TARGET}) determined by the outer loop power control is defined for the inner loop power control, even though there may be transmission on several slots simultaneously and interference in each time slot situation may have important differences.

References to FIG. 2a and FIG. 2b shall illustrate the deficiencies of such one common target signal to interference ratio (SIR_{TARGET}). FIG. 2a and FIG. 2b depict schematically level diagrams including abstract interference levels and target signal to interference ratio levels. In particular, FIG. 2a depicts abstract interference levels representing a first (physical channel) signal quality within a first time interval determined by the time slot TSᵢ and a second (physical channel) signal quality within a second time determined by the time slot TSᵢ₊₁. It shall be noted for the sake of completeness that a depicted high interference level denotes a low signal quality and a low interference level denotes correspondingly a high signal quality, respectively. The levels of the first and second signal quality are assumed to be identical, i.e. have the same interference levels. Additionally, an actual target signal to interference ratio level (SIR_{TARGET}) is illustrated. The target signal to interference ratio (SIR_{TARGET}) shall be autonomously adjusted by the outer loop power control mechanism based on cyclic redundancy check (CRC) measurements and a target service quality described with the help of the target block error ratio (BLER_{TARGET}). Therefore, the target signal to interference ratio (SIR_{TARGET}) from outer loop PC is the global measure results of all time slots, since cyclic redundancy check (CRC) results are calculated on the basis of all transport channels (TrCHs) in the coded composite transport channel (CCTrCH), which are transmitted in all time slots (including illustratively herein the time slots TSᵢ and TSᵢ₊₁) and assigned to the coded composite transport channel (CCTrCH).

Provided a common target signal to interference ratio (SIR_{TARGET}) is used for all time slots assigned to one coded composite transport channel (CCTrCH), the efficiency of the adaptation of the outer loop power control mechanism to interference conditions of each time slot is lowered. The lack of efficiency will get apparent with reference to FIG. 2b.

FIG. 2b depicts also abstract interference levels representing a first (physical channel) signal quality within a first time interval determined by the time slot TSᵢ and a second signal quality within a second time determined by the time slot TSᵢ₊₁. In contrast to the situation depicted in FIG. 2a, levels of the first and second signal quality are assumed to differ, i.e. the level of the first signal quality is significantly higher than the level of the second signal quality. Correspondingly, the interference level of the time slot TSᵢ₊₁ is higher than the interference level of the time slot TSᵢ.

For example, assuming again that the two time slots TSᵢ and TSᵢ₊₁ are associated with the one coded composite transport channel (CCTrCH), but the carrier to interference (C/I) condition in one slot increases greatly due to unwanted interference from other cells at one moment. The increase of the carrier to interference (C/I) condition results in a simultaneous increase of the interference level. Such an increase is depicted in FIG. 2b as described above. The increase of the interference level further results in an increase of cyclic redundancy check (CRC) measurement results indicating simultaneously that the service quality is also deteriorated. That means that the outer loop power control mechanism as enlightened above will adjust the common target signal to interference ratio (SIR_{TARGET}) accordingly. Such an autonomous adjustment performed by the outer loop power control mechanism on the basis of the signal and service qualities is illustrated in FIG. 2b. Starting from an actual common target signal to interference ratio (SIR_{TARGET}) which is denoted as old target signal to interference ratio (SIR_{TARGET}^{old}), an adjusted common target signal to interference ratio results from by the outer loop power control mechanism. The adjusted common target signal to interference ratio gets valid with its generation such that the adjusted common target signal to interference ratio replaces the actual/old common target signal to interference ratio (SIR_{TARGET}^{old}). Therefore, the adjusted common target signal to interference ratio is designated as new common target signal to interference ratio (SIR_{TARGET}^{new}).

The increase of the new common target signal to interference ratio (SIR_{TARGET}^{new}) will cause adjustment of the transmission power by increase not only in that time slot, which is subjected to the signal quality deteriorating carrier to interference (C/I) condition, but also in any other time slots associated with the coded composite transport channel (CCTrCH), even in case the interference condition is unchanged.

TDD system standard defines an offset between different time slots according to the interference levels, in order to adjust each of them to their corresponding interference level and carrier to interference (C/I) conditions, respectively. However, the TDD system standard does not define any way to do this, and therefore any implementation is vendor specific. There is one possibility to assign different offsets for the target signal to interference ratio (SIR_{TARGET}) of different time slots. The default implementation is to assume the same target signal to interference ratio (SIR_{TARGET}) for all the time slots, which is based on the block error ratio (BLER) measurement.

The inventive concept provides a method to determine a signal to interference ratio (SIR) offset applicable with each timeslot, also when a common target signal to interference ratio (SIR_{TARGET}) has been defined for a multislot connection.

Signal quality being represented by the target signal to interference ratio (SIR_{TARGET}) is based on the service quality being represented for instance by the target block error ratio (BLER_{TARGET}) and determined by the means of the measured block error ratio (BLERₘₑₐₛᵤᵣₑ). The measured block error rate (BLERₘₑₐₛᵤᵣₑ) corresponds to a global service quality measure for all the time slots in use. Therefore, the aforementioned individual behavior of a single time slot is blurred with the overall performance due to the fact that the conventional outer loop power control mechanism provides a common target signal to interference ratio (SIR_{TARGET}) determined on the basis of an overall interference condition of all time slots. However, a time slot relates service quality measure of each time slots TSᵢ is applicable to determine a relative increase or decrease of the common target signal to interference ratio (SIR_{TARGET}), in order to adapt the transmission power within each time slot TSᵢ in an improved way to their individual interference conditions and carrier to interference C/I conditions, respectively. The time slot relates service quality measure should individually represent the individual interference condition of an individual time slot.

FIG. 2c depicts abstract interference levels corresponding to FIG. 2b but with individual target signal to interference ratio levels (SIR_{TARGET}^{new}(i) and SIR_{TARGET}^{new}(i+1)) for the time slots TSᵢ and TSᵢ₊₁, respectively. As aforementioned, the individual target signal to interference ratio levels result from the common target signal to interference ratio (SIR_{TARGET}^{OLPC}) provided by the outer loop power control mechanism and individual signal to interference ratio offsets (ΔSIR(i)). The dependence can be mathematically denoted as following:
SIR_{TARGET}(i)=SIR_{TARGET}^{OLPC}+ΔSIR(i)
where for instance SIR_{TARGET}^{OLPC}=SIR_{TARGET}^{OLPC} (BLERₘₑₐₛᵤᵣₑ, BLER_{TARGET}) as described above.

The individual bit error ratio (BER(i)) of each time slots TSᵢ is applicable to determine a relative increase or decrease of the common target signal to interference ratio (SIR_{TARGET}).
SIR_{TARGET}(i)=SIR_{TARGET}^{OLPC}+Δ(BER_{RAW}(i)−BER_{RAW}^{combined})
where particularly Δ(X) represents a general function of the individual bit error ratios (BER_{RAW}(i)) for mapping the individual bit error ratios (BER_{RAW}(i)) to scale of the target signal to interference ratio (SIR_{TARGET}^{OLPC}) and where more particularly Δ(X) represents a general function for mapping differences between the individual bit error ratios (BER_{RAW}(i)) and a combined bit error ratio (BER_{RAW}^{combined}) to differences in scale of the target signal to interference ratio (SIR_{TARGET}^{OLPC}). It shall be noted that signal to interference ratios are typically defined on a decibel scale (dB). The combined bit error ratio (BER_{RAW}^{combined}) may be obtained generally from a combination of the individual bit error ratios (BER_{RAW}(i)), which can be mathematically denoted as following:
BER_{RAW}^{combined}=BER_{RAW}^{combined}(BER_{RAW}(i)).

A simple approach for determining the combined bit error ratio (BER_{RAW}^{combined}) would be obtained by averaging the individual bit error ratios (BER_{RAW}(i)). For example, a weighted averaging denotes mathematically as following:

$${BER}_{RAW}^{combined} = \frac{{\sum }_{i}^{n} {h}_{i} \cdot {BER}_{RAW} ( i )}{{\sum }_{i}^{n} {h}_{i}} , where {\sum }_{i}^{n} {h}_{i} = n .$$

Nevertheless other functional relationships and filtering procedures relating to the determining of the individual signal to interference ratio offset (ΔSIR(i)) and combined bit error ratio (BER_{RAW}^{combined}) can be implemented. Present invention is not limited to any specific functional relationship. Moreover, the present invention is not intended to be limited to bit error ratios (BER_{RAW}(i)) reflecting the service quality of individual time slots TSᵢ. Different service quality quantities may be used, which reflect suitably the service quality of an individual time slot TSᵢ.

With the inventive concept illustrated on the basis of a method according to an embodiment of the present invention the overall result would be similar as to have independent outer loop power control for each time slot, thus making it easier for the power control mechanism to find the optimal transmission power in each time slot.

The improved power control mechanism according to an embodiment of the present invention can be implemented as a modification of current power control mechanisms in the radio access network, i.e. the base station and radio network controller/base station controller) and/or cellular terminals. It has to be ensured that the improved power control mechanism according to an embodiment of the present invention can be supplied with the radio frequency link information representing service quality of the individual time slots. According to an embodiment of the present invention, suitable radio frequency link information can be bit error ratios, physical (raw) bit error ratios and the like which can be obtained from measurement reports.

One advantage of the improved power control mechanism according to an embodiment of the invention is that improved power control mechanism achieves lower (i.e. more optimum) transmission powers for the data transmission. This means that less interference in the radio network occurs such that radio limited frequency resources are handled economically and an increase in quality and/or capacity will be achieved. The implementation of the improved power control mechanism according to an embodiment of the invention on the basis of conventional power control mechanisms is easily manageable and the complexity of the improved power control mechanism is still acceptable.

Although the improved power control mechanism according to an embodiment of the invention has been described with respect to TD-SCDMA systems, those skilled in the art will easily appreciate that the improved power control mechanism applies to WCDMA-UTRAN-TDD systems. In particular downlink procedure of WCDMA-UTRAN-TDD systems adopts similar power control mechanism, with which the improved power control mechanism according to an embodiment of the invention is applicable.

With back reference to FIG. 1a, the individual service quality measures for each time slot have to be provided to the improved power control mechanism according to an embodiment of the invention. This is indicated in FIG. 1a by supplying physical channel conditions to the inner loop power controller 300, which may be responsible for determining the individual target signal to interference ratio levels (SIR_{TARGET}^{new}(i)) for the time slot TSᵢ on the basis of the common target signal to interference ratio (SIR_{TARGET}^{OLPC}) provided by the outer loop power control mechanism, herein more exactly the time delay compensated signal to interference ratio (SIR_{TARGET}^{OLPC}) and individual signal to interference ratio offsets (ΔSIR(i)). The individual signal to interference ratio offsets (ΔSIR(i)) are determined from time slot relates service quality measures of each time slots TSᵢ, which are comprised herein by the physical channel conditions supplied therefor.

With reference to FIG. 3, the operation of the improved power control mechanism according to an embodiment of the invention shall be described briefly. The system relevant for describing power control mechanism comprises on the one side the radio access network including at least one base station (BS) and a corresponding radio network controller (RNC) and on the other side at least one cellular terminal (UE).

In uplink, i.e. data communication from the cellular terminal (UE) to the base station (BS), the base station (BS) is responsible for issuing transmission power control (TPC) commands to the cellular terminal (UE). In a first operational step, the cellular terminal (UE) transmits radio frequency signals to the base station (BS), wherein the radio frequency signals are coded to contain data to be communicated. The base station (BS) receives radio frequency signals and is able to determine signal quality measures from the received signals. The data decoding is performed by the radio network controller (RNS), to which the received signals are transmitted by the base station (BS). The radio network controller (RNS) is able to determine service quality measures from the received signals which are converted by the radio network controller (RNC) to data originally provided by the cellular terminal (UE) and converted thereby to the signals for radio frequency transmission. The base station (BS) is now able to adapt the common target signal quality on the basis of the service quality measures performed by the radio network controller. According to the invention, the base station (BS) further takes service quality measures into account, which reflect the individual interference levels within time slots such that time slot individual target signal qualities are applicable for power control. Finally, the base station (BS) issues transmission power control (TPC) commands for each time slot and transmits the power control (TPC) commands to the cellular terminal (UE). The cellular terminal (UE) is now able to adapt its transmission power in accordance with the received transmission power control (TPC) commands. As it can be seen, the outer loop power control mechanism and the inner loop power control mechanism are distributed between the base station (BS) and the radio network controller (RNC).

In downlink, i.e. data communication from the base station (BS) to the cellular terminal (UE), the cellular terminal (UE) is responsible for issuing transmission power control (TPC) commands to the base station (BS). In a first operational step, the base station (BS) transmits radio frequency signals to the cellular terminal (UE), wherein the radio frequency signals code data to be communicated. The cellular terminal (UE) receives radio frequency signals and is able to determine signal quality measures from the received signals. The cellular terminal (UE) is further able to decode the received signals such that service quality measures from data resulting from the decoding are obtainable. The cellular terminal (UE) is now able to adapt the common target signal quality on the basis of the service quality measures. According to the invention, the cellular terminal (UE) further takes additionally the service quality measures into account, which reflect the individual interference levels within time slots such that time slot individual target signal qualities are applicable for power control. Finally, the cellular terminal (UE) issues transmission power control (TPC) commands for each time slot and transmits the power control (TPC) commands to the base station (BS). The base station (BS) is now able to adapt its transmission power in accordance with the received transmission power control (TPC) commands.

Although the invention has been described with reference to particular embodiments thereof, it will be apparent to those skilled in the art that modifications to the described embodiments may be made without departing from the spirit of the invention. Accordingly, the scope of the invention is only defined by the attached claims.

1. Method for improved power transmission controlling in duplex time division cellular systems supporting multislot services, comprising:
obtaining a common target signal quality level; and
obtaining individual service quality levels each relating to one of several individual time slots; wherein said individual time slots are assigned to one composite transport channel for a data stream resulting from combining of one or several transport channels;
determining individual target signal quality offset levels each relating to one of said individual time slots on the basis of said individual service quality levels; and
determining individual target signal quality levels each relating to one of said individual time slots on the basis of said common target signal quality levels and said individual target signal quality offset levels such that transmission power controlling is obtainable, which is adapted to specific interference conditions of each one of said individual time slots.

2. Method according to claim 1, comprising
determining said individual target signal quality offset levels by mapping said individual service quality levels from a service quantity scale to a signal quantity scale.

3. Method according to claim 1, comprising
mapping a difference between said individual service quality levels and a combined individual service quality level for determining said individual target signal quality offset levels.

4. Method according to claim 3, wherein said combined individual service quality level is a function of said individual service quality levels.

5. Method according to claim 1, wherein said individual service quality levels are bit error ratios.

6. Method according to claim 1, wherein said common target signal quality level is adjusted in accordance with a common target service quality level and a common measured service quality level being determined from said data transmitted on said composite transport channel.

7. Method according to claim 1, wherein said common target signal quality level is obtainable from an outer loop power control mechanism.

8. Method according to claim 1, wherein said common target signal quality level is a common target signal to interference ratio.

9. Method according to claim 1, said transmission power controlling is capable for issuing transmission power control commands for each time slot, wherein said transmission power controlling is applicable for data communications in uplink and/or downlink direction.

10. Method according to claim 1, wherein said composite transport channel is a coded composite transport channel.

11. Method according to claim 1, wherein said time division duplex cellular system is a wideband code division multiple access—time division duplex (WCDMA-TDD) system and particularly a time division synchronous code division multiple access (TD-SCDMA) system.

12. Computer program product for executing a method for improved transmission power controlling in duplex time division cellular systems supporting multislot services, comprising program code sections for carrying out the steps of claim 1, when said program is run on a computer, a terminal, a network device, a mobile terminal or a mobile communication enabled terminal.

13. Computer program product for executing a method for improved transmission power controlling in duplex time division cellular systems supporting multislot services, comprising program code sections stored on a machine-readable medium for carrying out the steps of claim 1, when said program product is run on a computer, a terminal, a network device, a mobile terminal, or a mobile communication enabled terminal.

14. Computer data signal embodied in a carrier wave and representing instructions, which when executed by a processor cause the steps of claim 1 to be carried out.

15. Transmission power controller for time division duplex cellular systems supporting multislot services, comprising at least
means for obtaining a common target signal quality level;
means for obtaining individual service quality levels each relating to one of several individual time slots; wherein said individual time slots are assigned to one composite transport channel for a data stream resulting from combining of one or several transport channels;
means for determining individual target signal quality offset levels each relating to one of said individual time slots on the basis of said individual service quality levels; and
means for determining individual target signal quality levels each relating to one of said individual time slots on the basis of said common target signal quality level and said individual target signal quality offset levels such that said transmission power controller is able specifically adapt transmission power to individual interference conditions of each one of said individual time slots.

16. Transmission power controller according to claim 15, wherein said means for determining individual target signal quality offset levels comprises
means for mapping said individual service quality levels from a service quantity scale to a signal quantity scale.

17. Transmission power controller according to claim 15, comprising
means for mapping a difference between said individual service quality levels and a combined individual service quality level for determining said individual target signal quality offset levels.

18. Transmission power controller according to claim 15, comprising
means for adjusting said common target signal quality level in accordance with a common target service quality level and a common measured service quality level being determined from said data transmitted on said composite transport channel.

19. Transmission power controller according to claim 15, wherein said individual service quality levels are bit error ratios.

20. Transmission power controller according to claim 15, wherein said common target signal quality level is a common target signal to interference ratio.

21. Transmission power controller according to claim 15, comprising
outer loop power control mechanism from which said common target signal quality level is obtainable.

22. Transmission power controller according to claim 15, wherein said transmission power controller is provided for wideband code division multiple access—time division duplex (WCDMA-TDD) systems and particularly for time division synchronous code division multiple access (TD-SCDMA) systems.

23. Cellular terminal capable to operate in a cellular time division duplex system supporting multislot services, comprising at least a transmission power controller for adjusting transmission power control of downlink data transmissions, wherein said transmission power controller is a transmission power controller according to claim 15.

24. Base station for cellular time division duplex system supporting multislot services, comprising at least a transmission power controller for adjusting transmission power control of uplink data transmissions, wherein said transmission power controller is a transmission power controller according to claim 15.

25. Radio access network system of a cellular time division duplex system supporting multislot services, wherein said radio access network system comprises at least one base station and at least on radio network controller, wherein said radio access network system comprises additionally a transmission power controller for adjusting transmission power control of uplink data transmissions, wherein said transmission power controller is a transmission power controller according to claim 15.

26. Method according to claim 2, comprising mapping a difference between said individual service quality levels and a combined individual service quality level for determining said individual target signal quality offset levels.

27. Method according to claim 6, wherein said common target signal quality level is obtainable from an outer loop power control mechanism.

28. Transmission power controller according to claim 16, comprising means for mapping a difference between said individual service quality levels and a combined individual service quality level for determining said individual target signal quality offset levels.
